(19) United States
(12) Patent Application Publication
(10) Pub. No.: US 2010/0179920 A1
(43) Pub. Date: Jul. 15, 2010

(54) Retirement age financial simulator

(75) Inventor: Mark Snodgrass, Corvallis, OR (US)

Correspondence Address: Robert J. Ireland, P.O. Box 273, Banks, OR, 97106, US

(73) Assignee: Money Tree Software, Corvallis, OR (US)

(21) Appl. No.: 12/319,981

(22) Filed: Jan. 15, 2009

(51) Int. Cl. G06Q 40/00

(52) U.S. Cl. 705/36 R; 705/35

(57) ABSTRACT

The present invention provides the user a financial retirement simulation tool that accepts user inputs like investment portfolio value, retirement age ranges and post retirement spending rules based on the retirement circumstance, further inputs are included like projected market performance and inflation impact assumptions, the invention then simulates a multitude of retirement financial scenarios at various retirement ages and various post retirement spending levels with the retirement circumstance dynamically simulated with the market performance and inflation impact assumptions modified within a statistically acceptable range using the Monte Carlo technique, resulting in a plurality of potential retirement financial scenarios with probabilities of those scenarios occurring.

### CROSS-REFERENCE TO RELATED APPLICATIONS

This non-provisional application for utility patent claims the earlier filed provisional application filed Jan. 11, 2008, Application No. 61/010,708.

### STATEMENT REGARDING FEDERALLY SPONSORED RESEARCH OR DEVELOPMENT

This invention is not the product of any Federally Sponsored Research or Development.

Contained herein are materials subject to copyright protection.

### COPYRIGHT NOTICE

The copyright owner Money Tree Software, Ltd. does not object to the copying, reproduction, or publication of this application for patent as it appears in the Patent and Trademark Office, Records, or Files. Money Tree Software, Ltd. does reserve all other intellectual property rights specifically including all rights to the copyright.

### BACKGROUND OF THE INVENTION

1. Technical Field

The present device relates generally to financial simulation.

2. Discussion of Related Art

In planning for retirement, the primary factors individuals may securely control in their retirement future are the year they retire, their post retirement spending, and their range of tolerable post retirement spending habits. The factors the user can't control are market performance impact on their retirement asset portfolio, and inflation effects on their post retirement spending. To better financially advise an individual, the financial planner illustrates potential and/or likely market and inflation conditions and analysis the various investment, retirement, and spending options available. Investment options such as tax advantaged retirement accounts, savings plans, stock or fund purchases, interest bearing accounts, tax advantaged investments or other kinds of financial vehicles can have different impacts on retirement success. Different retirement ages can affect retirement benefit levels, retirement asset levels, and retirement asset returns. Planned retirement spending levels and asset withdrawal strategies affect retirement asset sustainability. These various combinations of options would be analyzed in light of the many possible financial outcomes based on assumptions about the future. Those mentioned assumptions are subjective, but based on historic information, analysis, and informed speculation. Simulation further illustrates how retirement may financially look, if a certain range of assumed conditions are met. As the future is uncertain, the professional financial planner works to illustrate ranges of likely market and inflation conditions, determine some reasonable combination of investments, actions and spending levels, and the user acts accordingly. As with the stock market, retirement success is not guaranteed, the random or unforeseen conditions can materially differ from expectations. As professional financial planners work to analyze and illustrate options, their assumptions and calculations must be conservative enough to reduce the user's exposure to financial ruin.

Dynamic modeling of retirement finances is one of the demonstrations professional financial planners perform in order to facilitate retirement planning discussion and decision. The planner illustrates potential future financial outcomes based on assumptions and mathematic calculations. Assumptions include future financial market performance, achieving periodic savings objectives, maintenance of retirement withdrawal goals, and changes relating to cost of living. Mathematical calculations include basic interest calculations, inflation estimators, tax estimates, historic extrapolation, general algebra, and financial calculus. The assumptions and calculations are reduced and merged into textual, graphical and tabular formats depicting potential financial futures, allowing for easy review and understanding.

In previous computer generated demonstrations, the planner would request from the prospective retiree information relating to their personal circumstance such as their age, the retirement age the user desires to cease contributing financially, yearly income, health insurance and if applicable retirement health insurance, social security, adversity to investment risk, retirement income, pensions, or other incomes, current personal savings, current real estate holdings and mortgages, insurance policies that may affect financial circumstance, loans and debts and other major anticipated expenses or incomes. Initial retirement principal and prospective periodic savings deposits are balanced against estimated future withdrawal rates using the retirement age as a major milestone where earnings end, and retirement spending begins, carried over the estimated life years remaining. The prospective retiree evaluates the demonstration against his or her retirement goals and retirement financial needs, financially plans accordingly relying on the investment strategy, and saves or invests accordingly, targeting the specific retirement age as the last age the user has to contribute. The user's retirement age dictates the simulation limiting user choice and option.

The above described process is flawed in that it requires the user to “guess” what age he/she will retire, then “guess” the future performance of assets, and “guess” future inflation. A retirement calculation runs from the “guessed” retirement date simulating portfolio value minus post retirement spending, extrapolating out until the portfolio is depleted or estimated life years have run. The lifestyle, spending habits, and desired retirement income are adjusted by the simulation to meet the criteria for retirement success based upon the user's “guessed” retirement date. Without consideration of lifestyle, spending habits, or desired retirement income, retirement is considered and decided on by a first guessed retirement date. The date of retirement is selected before consideration is given as to when the user may be able to retire without changing lifestyle, spending habits, or his/her desired retirement income.

It is desirable to provide the user a “What if?” look into the future. “What if I retire at age 58, what are the odds I will not run out of money?” “What age could I retire at if I was willing to accept a 25% chance of running out of money?” “Would my odds change if I set post retirement spending as a fraction of portfolio value?” The odds or chance of reaching and maintaining retirement goals is a consideration professional financial planners utilize to assist users in their retirement financial planning.

U.S. Pat. No. 6,012,043, inventor Albright, teaches a computer implemented tool for retirement planning which first requires an input of “customer” information including desired retirement age, and then from that information, produces estimated values of needed savings levels and further income based on certain economic guesses and historical data regarding the individual customer's current financial status and the historical performance of user investments. The Albright method patent does produce a retirement path, but doesn't account for the randomness of user life, the market, inflation, changes in spending habits, choices regarding the user' retirement year, and unexpected occurrences. The system uses no dynamic rule based calculation branching and uses no Monte Carlo modeling to illustrate variable conditions. In short the Albright method performs a singular analysis of estimation, not thousands of financial paths each modified for randomness, and spending adjusted as a function of portfolio value or performance.

The method of using the Monte Carlo simulation to predict financial futures is well known in the art and inventor Kant, U.S. Pat. No. 6,772,136, teaches a software synthesis method and system that provides conversion from a user specification in natural language into a Monte Carlo simulation wherein the variables that are subject to randomness are accounted for. The pseudo-code is translated into the desired target language, source code and the simulation is computer facilitated. Possible outcomes are predicted based on the user specification. However, on-going retirement simulation after retirement date when working income is no longer contributed, is not taught, suggested, or practiced in #136.

Other examples of patents for valuing financial instruments and strategies include U.S. Pat. Nos. 5,692,233; 5,872,725; and 5,940,810 (incorporated by reference).

### DESCRIPTION OF THE PRESENT INVENTION

The present invention performs retirement modeling using known variables like present day value of allocated retirement assets and spending requirements, along with unknown variables such as market performance and inflation effect, which are modified within a statistically acceptable range using the Monte Carlo technique. A collection of target retirement ages are included in the input of data required from the user along with post retirement spending rules that intelligently adjust based on the retirement circumstance. Simulation of the unknown future values of the invested portfolio balanced against simulation of the desired retirement withdrawal rates provide possible financial paths leading to user defined retirement success. Along each successful path there is a retirement age wherein the user no longer has to contribute financially, but still achieves retirement success, thus dynamically determining one possible retirement age. The successful financial retirement path includes the retirement age of one success, but does not guarantee retiring at that age would be successful as many post retirement occurrences could impact the scenario. Running thousands of simulations continuing after retirement age, yield a plurality of possible retirement scenarios, thus expanding options for retirement, rather than limiting retirement options to a single retirement age.

During one embodied simulation, a plurality of possible retirement paths are computed using the rule based Monte Carlo technique. Randomly generated variables within possible ranges that affect the future performance of the allocated retirement assets and retirement withdrawals are computed to produce possible linear paths representing possible financial outcomes. This simulated financial reality is “lived in” by the user, with the user's inputs relating to post retirement spending rules, life years remaining, and retirement age considerations dictating whether or not the simulated linear path equates to a retirement success, or a failure.

In one embodiment, retirement age is dynamically determined within each Monte Carlo simulation based upon user entered acceptable retirement criteria measured against simulated asset value and cost of living results within each calculation year, where the ages are within the retirement target age range. The user sets the retirement target age range and the invention simulates post retirement conditions against user spending criteria over life expectancy years, giving vision as to whether the user will run out of money before life years. In one embodied scenario, after retirement date is determined, annual retirement spending is varied within each calculation year based upon user assigned criteria that adjusts to simulated market performance and/or portfolio value. The user for example could define retirement spending as a variable equating to no more than four percent and no less than three percent of the retirement asset principal. The resulting composite of Monte Carlo simulations with dynamically determined retirement ages and dynamically calculated retirement spending levels, account for a wide range of statistically probable outcomes in the future financial circumstance.

The dynamic assignment of retirement age and retirement spending helps the user gain insight on the nature and effect of intelligent and reactive decision making on the success of potential retirement paths affected by a wide array of probable market and economic conditions. Most retirement simulations do not account for any future user decision making when the retirement financial circumstance changes. The present invention allows the user to include rules within the retirement simulation system to model future intelligent reactions to a multitude of different retirement conditions and circumstance. The user may then draw educated conclusions regarding assortments of probable retirement ages and spending levels with decision criteria in the retirement simulation collection that yield desirable retirement outcome, using probability considerations, not afforded by straight deterministic modeling using only single-point estimates or guesses.

As mentioned, contrary to the present invention might be considered deterministic modeling, which uses guesses or educated assumptions. Each uncertain variable within a deterministic model is assigned an assumption. Various combinations of each collection of assumptions or input variables are manually chosen (such as best market performance, worst market performance, and most likely market performance), and the simulation results recorded for each calculated scenario when the variables used to compute are all singular estimates.

In direct contrast, the present invention considers random sampling of probability distribution functions as model inputs to produce hundreds and thousands of possible outcomes instead of a few discrete user selected singular scenarios. The results of the Monte Carlo technique on simulation variables provide probabilities of different outcomes occurring in the future. For example, a comparison of a retirement simulation using traditional deterministic modeling compared to the same user situation simulated again with the Monte Carlo technique with modified variables, the compared distributions would show that the Monte Carlo analysis benefits from a narrowed more-likely-than-not range of results than the deterministic result which provides a single estimated outcome. This is because the deterministic simulation gives equal weight to all scenarios simulated due to the absence of probability inclusion in the calculation.

The present invention benefits from the Monte Carlo technique in modifying unknown future variables like market performance, simulating over a multitude of statistically probable financial scenarios or paths, dynamically adjusting the simulation via user rules for retirement age and/or retirement spending, giving occurrence weight to the more likely scenarios, providing the user a statistically realistic look into the retirement future.

### REFERENCES

R. E. Caflisch, Monte Carlo and quasi-Monte Carlo methods, Acta Numerica vol. 7, Cambridge University Press, 1998, pp. 1-49.

Arnaud Doucet, Nando de Freitas and Neil Gordon, Sequential Monte Carlo methods in practice, 2001,

C. P. Robert and G. Casella. “Monte Carlo Statistical Methods” (second edition). New York: Springer-Verlag, 2004,

R. Y. Rubinstein and D. P. Kroese (2007). “Simulation and the Monte Carlo Method” (second edition). New York: John Wiley & Sons,

Judgement under Uncertainty: Heuristics and Biases, ed. D. Kahneman and A. Tversky,(Cambridge University Press, 1982)

### FIGURE DESCRIPTIONS

FIG. 1 is a block diagram depicting an overview of one embodiment of the computer implemented method of the present invention;

FIG. 2 is a graphic output report of an exemplar simulation; and

FIG. 3 is a block diagram illustrating a third embodiment of the computer implemented method of the present invention.

### DETAILED DESCRIPTION OF THE PREFERRED EMBODIMENT

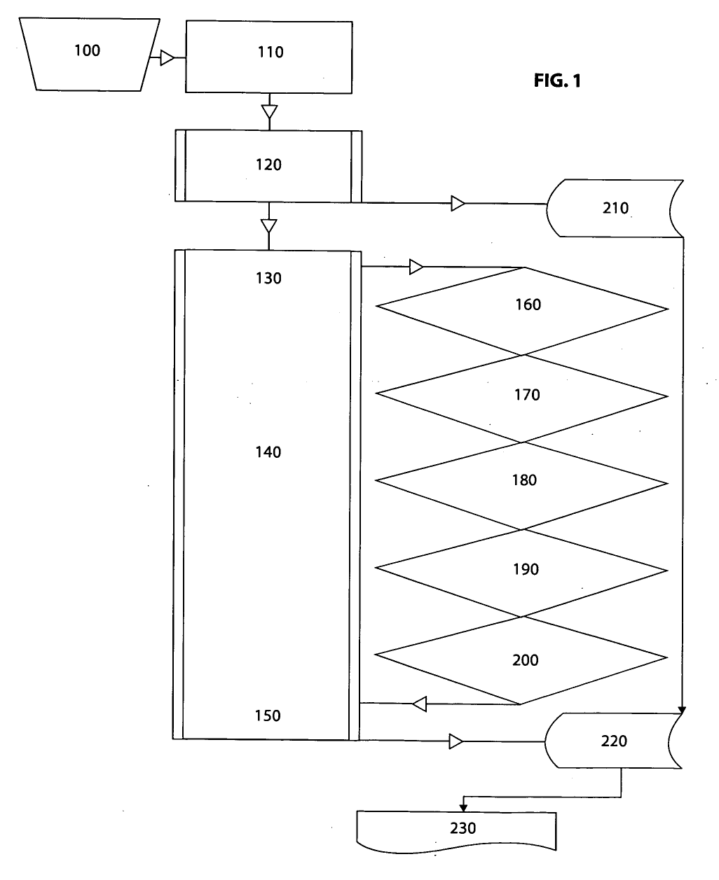

Referring now to the block diagram illustrations of FIG. 1-3, information regarding the user's financial circumstance, static assumptions, and financially acceptable retirement conditions are entered into a computer as user input. The user inputs may further include those things that the user can control, such as acceptable retirement age range, post retirement spending levels, and the range that said spending can be considered acceptable. For example, one of the user inputs could be that post retirement spending would not exceed four percent of the principal of the portfolio. This user defined input will create a defined variable in the simulation that the computer will use to simulate post retirement financial scenario as well as a rule to determine when simulation conditions are such that retirement age be set, and withdrawal can begin.

The static assumptions can be loosely derived from past market performance, current market conditions, and guesses relating to future market performance. Static assumptions also account for guesses relating to the inflation effect, cost of living, and portfolio valuation impacts. The future is unknown, however presumed ranges of probability can be used with the Monte Carlo technique to more accurately model potential or probably outcomes.

Looking to FIG. 1 showing one embodiment, a loop using deterministic modeling, calculating one full plan scenario without using the Monte Carlo technique, would illustrate what the retirement scenario will look like if the static assumptions are followed and occur without variance to probability. Each uncertain variable within the deterministic model is assigned an assumption. Various combinations of each collection of assumptions or input variables are manually chosen and entered as static assumptions (such as best market performance, worst market performance, and most likely market performance), and the deterministic modeling simulation results recorded for each “what if” scenario are stored for comparison to the Monte Carlo loop.

Starting with the Monte Carlo loop, the embodiment illustrated in FIG. 1 modifies the static assumptions. The results of the Monte Carlo technique on simulation variables provide probabilities of different outcomes occurring in the future. The Monte Carlo technique when used in simulation, considers random sampling of probability distribution functions as model inputs to produce hundreds, thousands, or tens of thousands of possible outcomes instead of a few discrete user selected “what if” scenarios. This embodiment provides for market shift, random financial occurrences, changes of circumstance, and more closely simulates the real potential economic environment and future. A plurality of financial planning loop calculations and/or methods are performed utilizing a Monte Carlo technique, wherein a plurality of multi-year financial plan simulations are generated utilizing a statistically appropriate set of randomly created values for unknowable future economic conditions such as asset performance, inflation, and cost of living. In this Monte Carlo loop or simulation, the dynamic variables are not user defined or guessed at, but instead are limited by statistically known or accepted ranges. Within each Monte Carlo loop, retirement at a particular age is dynamically determined based upon rules related to asset levels and plan performance up to the target age range. Spending levels after retirement age are dynamically adjusted based upon rules related to spending objectives and asset levels and plan performance up to the year in question.

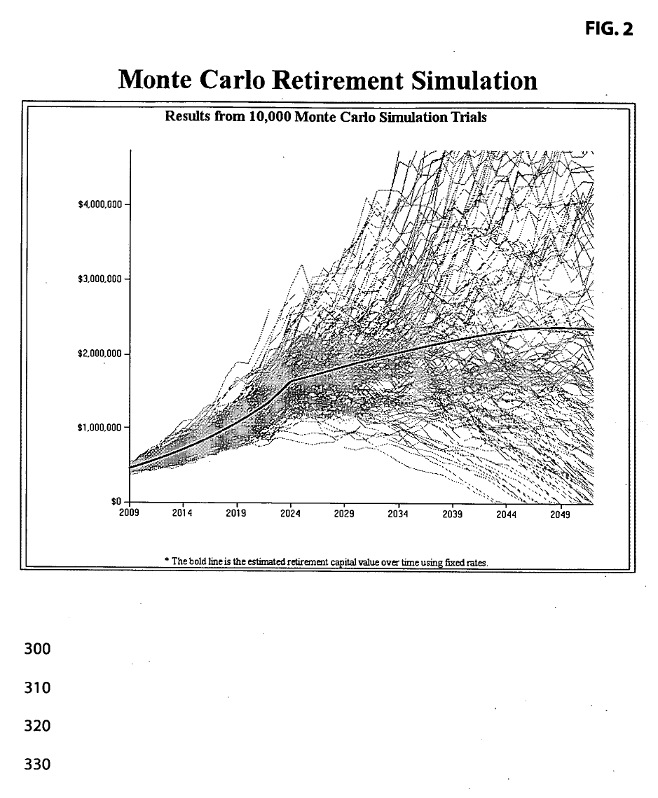

The report representing the stored results of the deterministic modeling and rule based Monte Carlo technique can be compared as shown in FIG. 2, giving the user not only subjective “what if” analysis, but also “what likely will happen if I follow this pattern” analysis. The lines represent a multitude of possible occurrences. Results include effects of randomized market and inflation conditions as well as the effects of intelligent responses to hypothetical conditions. For example, if the asset portfolio drops it's value to half, then post retirement spending may have to be cut in half to accommodate, but the overall chances of still having money for the remaining life years is increased.

In FIG. 2, an example Retirement Summary is displayed showing results from 10,000 Monte Carlo Simulations. The analysis shows years on the horizontal axis and capital asset value on the vertical axis. Possible financial retirement scenarios in growth or depletion of retirement capital under unpredictable future conditions are represented by jerky lines, each simulating a possible scenario under the probable conditions. The smooth rolling bold line represents the trend of uncertainty, without presupposing investment strategy. Each retirement financial scenario introduces uncertain conditions by using the Monte Carlo technique to fluctuate annual rates of return. The fluctuations suggested may never happen, but the possibility that the fluctuation may occur is displayed for consideration.

Based upon the trends, changes and values shown in the hypothetical simulations displayed in FIG. 2, the user can draw conclusions. By using random rates from statistically appropriate collection of annual returns, and repeating the process thousands of times, the resulting collection can be viewed as a representative set of potential future results. The tendencies within the group of Monte Carlo Simulation results; the highs, lows, and averages, offer insight into potential spending plan performance which may occur under the combination of broad market conditions. The present invention provides the user a test bed for varying retirement age, varying post retirement spending strategy, and for accommodating possible shortened life expectancy.

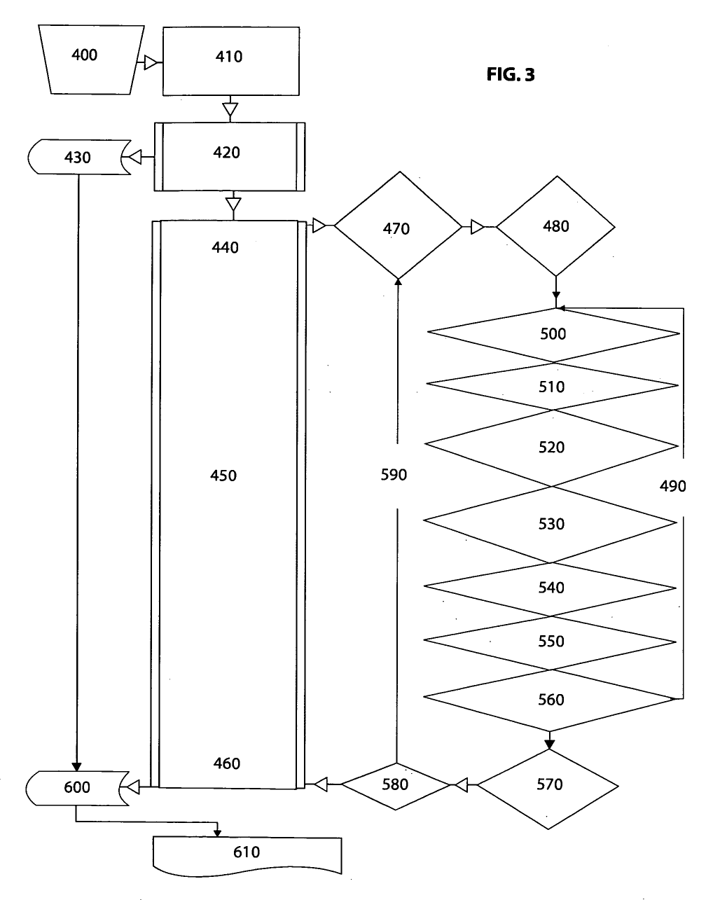

In FIG. 3, the displayed embodiment accepts user input information and static assumptions, and the user requested a report. One full retirement plan based on user inputs and static assumptions is accomplished, the results are stored and reflect one static path of retirement, using static assumptions to mimic market performance and/or inflation effect. The result of this first loop of simulation provides “what if” scenarios. What if the market grows at seven percent a year, what will retirement finances look like? What if the inflation factor remains at two percent, but the market is unable to keep up? These “what if” financial scenarios are well known in the art, but fail to account for the random probability of the future, and instead rely upon specific assumptions to predict in simulation. In the embodiment illustrated in FIG. 3, one assumed retirement scenario is calculated as one full financial plan based upon user selected inputs and static assumptions, without the benefit of the Monte Carlo technique, leaving the static assumptions as inputted by user.

After the simulation of the assumed static assumptions, the computer starts the Monte Carlo. In FIG. 3 it is further shown, in each of the Monte Carlo loop simulations, the computer dynamically modifies additional variables based on changing conditions within the simulation in response to rule based decision criteria. For example, the assumed market performance is modified by the Monte Carlo technique to reflect a range of possible market performance outcomes, within the range of probable occurrences using rule based decision criteria. Rule based decision criteria provide the construct or range of statistically acceptable variations converting the static assumptions to dynamic variables. Also, within each of the Monte Carlo loop simulations, the computer accumulates financial plan results, including but not limited to dynamically calculated retirement age and post retirement spending information. Both the retirement age and/or post retirement spending may adjust within the rules provided by the user and converted into formula for the simulation.

As FIG. 3 illustrates, a multi-year plan calculation simulated wherein the first year calculation begins with calculating beginning asset and account valuations. The annual portfolio growth/reduction and annual inflation is dynamically varied within statistically acceptable variation for each year, as each year is simulated the retirement portfolio and inflation effect will modify as per the Monte Carlo technique. Calculating from a formula for retirement age, the computer, using dynamically modified retirement asset values (modified by the Monte Carlo technique), determines if the user could stop contributing to the retirement asset, and begin withdrawing. The beginning withdraw date is essentially one potential retirement age, and the computer continues to simulate the scenario. Using a formula for post retirement spending, the computer uses the Monte Carlo technique to vary asset value simulating post retirement years until the end of life expectancy. The results stored provide the user potential outcomes based on potential market occurrences that are within the probable statistical range, all the while during the simulation post retirement spending adjusts as a function of asset performance and value. Once the multi-year simulation is complete, results are tabulated, and stored. A graphical report is generated based on user preference. The report provides the user a full plan outcome based off of guesses and estimated future occurrences, with a complimenting plurality of potential plans created using the Monte Carlo technique to modify the known static variables into dynamic variables within probable occurrence.

Both FIG. 1 and FIG. 3 demonstrate further innovation within the Monte Carlo Loop wherein the retirement age and post retirement spending is adjusted using a formula. The formula is constructed from a rule based criterion that looks to the retirement asset value, balances against the number of years of life expectancy, and adjusts either the retirement age, or post retirement spending, or both. For example in one embodiment, post retirement spending could be a function of retirement asset value divided by life expectancy years, plus or minus market performance. If the market does well the simulation “spends” more as per the user rule based criteria, or if the retirement asset drops in value, the formula decreases spending, thus simulating intelligent behavioral retirement spending. This intelligent behavioral spending formula dynamically follows the Monte Carlo simulated market conditions giving the user not only a look at what might happen with the assets, but what might happen if the user intelligently adjusted spending and/or retirement age.

Based upon the trends, changes, and values shown in the hypothetical financial simulation of FIG. 2, the simulation process uses different random rate of return for each year. Thousands of financial plan calculations are performed utilizing volatile annual rates of return. The output is the displayed graphical report of hypothetical financial plan results illustrating future financial market environments.

By using random rates from statistically appropriate collection of annual returns, and repeating thousands of times the Monte Carlo technique in process shown in FIG. 1, and FIG. 3, the resulting collection can be viewed as a representative set of potential future results as illustrated in FIG. 2. The tendencies shown in FIG. 2, within the group of results from the Monte Carlo technique; the highs, lows, and averages, offer the user insight into potential plan performance which may occur under the various combination of probable broad market conditions.

### OBJECTS AND ADVANTAGES

There are several objects and advantages of the present method:
a) to provide a retirement simulation that calculates using static variables and dynamic variables modified by the Monte Carlo technique;
b) to provide an illustration of potential success probability at each retirement age;
c) to provide an illustration of variable spending probability patterns at each retirement age;
d) to provide a simulation wherein the user defines retirement age, user portfolio information, and spending requirements within a spending range, and the computer modifies market performance and inflation effect using the Monte Carlo technique, resulting in a range of possible retirement scenarios within statistically probable occurrences;
e) to provide a simulation after the retirement year, using portfolio value as an adjusted variable calculated using possible market performance and/or inflation effect modified by the Monte Carlo method, reduced by user spending;
f) to provide each possible retirement age an after retirement analysis of probable financial outcome;

Still further objects and advantages will become apparent from consideration of the following description and drawings.

### SUMMARY

In accordance with the present invention, a computer implemented tool for financial retirement simulation, comprising an input means for receiving user information, static assumptions, and dynamic variable parameters, a means to simulate one full retirement scenario with user information and static assumptions without using the Monte Carlo technique to randomize the static assumptions, and means for storing the result of one full retirement scenario simulation with user information and static assumptions, subsequent simulation of multiple full retirement scenarios with user information and static assumptions, modifying the static assumptions with the Monte Carlo technique into dynamic variables within the dynamic variable parameters and a means for storing results of multiple full retirement scenario simulations with user information and dynamic variables, using the innovative dynamic rule based technique to determine retirement age and retirement spending decisions within each Monte Carlo simulation iteration and a means for storing retirement ages and spending levels along with associated retirement outcomes, and output means for generating a graphical output report of stored results illustrating the simulated retirement scenarios.

What is claimed is:

1. For use in a computer implemented tool for financial retirement simulation, comprising:
input means for receiving user information, static assumptions, and dynamic variable parameters;
means to simulate one full retirement scenario with user information and static assumptions;
means for storing the result of one full retirement scenario simulation with user information and static assumptions;
means to simulate multiple full retirement scenarios with user information and static assumptions, modifying the static assumptions by the Monte Carlo technique into dynamic variables within the dynamic variable parameters;
means for storing results of multiple full retirement scenario simulations with user information and dynamic variables; and
output means for generating a graphical output report of stored results illustrating the simulated retirement scenarios.

2. A computer implemented tool for financial retirement simulation of claim 1, wherein the user information includes portfolio of current assets including cash, stocks, savings, income, real estate or other fungible holdings.

3. A computer implemented tool for financial retirement simulation of claim 1, wherein the user information includes rules varying retirement age based on retirement asset performance.

4. A computer implemented tool for financial retirement simulation of claim 1, wherein the user information includes rules varying post retirement spending based on retirement asset performance.

5. A computer implemented tool for financial retirement simulation of claim 1, wherein the user information includes user life years remaining, and user's potential retirement ages.

6. A computer implemented tool for financial retirement simulation of claim 1, wherein the static assumptions include historic financial market performance, historic inflation effect, expected market performance, and expected inflation effect.

7. A computer implemented tool for financial retirement simulation of claim 1, wherein the user information includes user post retirement spending requirements or allowable range of post retirement permissible spending variations.

8. A computer implemented tool for financial retirement simulation of claim 1, wherein the output means includes illustrations of financial retirement simulation after retirement age.

9. A computer implemented tool for financial retirement simulation of claim 1, wherein the full retirement scenario simulation includes simulation of multiple retirement ages.

10. A computer implemented tool for financial retirement simulation of claim 1, wherein the user information includes portfolio value, retirement ages, and user life years; and the output means include illustrations of simulated portfolio value for a plurality of retirement ages, simulated over user life years.

11. For use in a computer implemented tool for financial retirement simulation, comprising:
input means for receiving user information, static assumptions, and dynamic variable parameters;
means to simulate multiple full retirement scenarios with user information and static assumptions, said static assumptions modified by the Monte Carlo technique into dynamic variables within dynamic variable parameters;
means for storing results of multiple full retirement scenario simulations with user information and dynamic variables; and
output means for generating a graphical output report of stored results illustrating the simulated retirement scenarios.

12. A computer implemented tool for financial retirement simulation of claim 11, wherein the user information includes user life years remaining, life expectancy variation parameters, portfolio of current assets including cash, stocks, savings, income, real estate or other fungible holdings.

13. A computer implemented tool for financial retirement simulation of claim 11, wherein the user information includes user's financial goal or goals.

14. A computer implemented tool for financial retirement simulation of claim 11, wherein the static assumptions include historic financial market performance, historic inflation effect, expected market performance, and expected inflation effect.

15. A computer implemented tool for financial retirement simulation of claim 11, wherein the user information includes user post retirement spending requirements and allowable range of post retirement permissible spending variations.

16. A computer implemented tool for financial retirement simulation of claim 11, wherein the output means includes illustrations of financial retirement simulation after retirement age.

17. A computer implemented tool for financial retirement simulation of claim 11, wherein the full retirement scenario simulation includes simulation of multiple retirement ages.

18. A computer implemented tool for financial retirement simulation of claim 11, wherein the user information includes portfolio value, retirement ages, and user life years; and the output means include illustrations of simulated portfolio value for a plurality of retirement ages, simulated over user life years.

19. A computer implemented tool for financial retirement simulation of claim 11, wherein the user information includes rules varying retirement age based on retirement asset performance.

20. A computer implemented tool for financial retirement simulation of claim 11, wherein the user information includes rules varying post retirement spending based on retirement asset performance.
